(19) United States
(12) Patent Application Publication
(10) Pub. No.: US 2012/0200963 A1
(43) Pub. Date: Aug. 9, 2012

(54) SYSTEM AND METHOD FOR PROTECTING A COMPUTING DEVICE USING VSD MATERIAL, AND METHOD FOR DESIGNING SAME

(76) Inventors: Daniel Vasquez, Mountain View, CA (US); Lex Kosowsky, San Jose, CA (US)

(21) Appl. No.: 13/291,090

(22) Filed: Nov. 7, 2011

Related U.S. Application Data
(63) Continuation-in-part of application No. 11/860,530, filed on Sep. 24, 2007, now Pat. No. 7,793,236.
(60) Provisional application No. 61/410,922, filed on Nov. 7, 2010.
(60) Provisional application No. 60/943,556, filed on Jun. 13, 2007.

(51) Int. Cl. H02H 9/04; G06F 17/50

(52) U.S. Cl. 361/56; 716/122

(57) ABSTRACT

Embodiments described herein provide for programmatic design or simulation of substrates carrying electrical elements to integrate voltage switchable dielectric (“VSD”) material as a protective feature. In particular, VSD material may be incorporated into the design of a substrate device for purpose of providing protection against transient electrical conditions, such as electrostatic discharge (ESD).

### RELATED APPLICATIONS

This application claims benefit of priority to Provisional U.S. Patent Application No. 61/410,922, filed Nov. 7, 2010; the aforementioned priority application being hereby incorporated by reference in its entirety.

This application is also a Continuation-in-Part of U.S. patent application Ser. No. 11/860,530 entitled SYSTEM AND METHOD FOR INCLUDING PROTECTIVE VOLTAGE SWITCHABLE DIELECTRIC MATERIAL IN THE DESIGN OR SIMULATION OF SUBSTRATE DEVICES, filed Sep. 24, 2007 and issued as U.S. Pat. No. 7,793,236 on Sep. 7, 2010, which claims benefit of priority to Provisional U.S. Patent Application No. 60/943,556, entitled SYSTEM AND METHOD FOR PROGRAMMATICALLY DESIGNING ELECTRONIC DEVICES USING VOLTAGE SWITCHABLE DIELECTRIC MATERIAL, filed Jun. 13, 2007; the aforementioned priority applications being hereby incorporated by reference in its entirety.

### BACKGROUND

Electronic devices are often fabricated by assembling and connecting various components (e.g., integrated circuits, passive components, chips, and the like, hereinafter “chips”). Many components, particularly semiconductors, are sensitive to spurious electrical events that apply excessive voltage to the devices in what is termed an overvoltage condition. Examples of sources of overvoltage conditions include electrostatic discharge (ESD), back electromotive force (EMF), lightning, solar wind, switched electromagnetic induction loads such as electric motors and electromagnets, switched heavy resistive loads, large current changes, electromagnetic pulses, and the like. Overvoltage conditions may result in a high voltage at a device containing active and/or passive electronic components or circuit elements, such as a semiconductor IC chip, which may cause large current flow through or within the components. The large current flow may effectively destroy or otherwise negatively impact the functionality of such active or passive components or circuit elements.

Some chips include “on-chip” protection against some overvoltage events (e.g., a mild ESD event) that may be expected during packaging of the chip or operation of the respective electronic device (e.g., protection against Human Body Model events).

A chip may be packaged (e.g., attached to a substrate). A packaged chip may be connected to additional (e.g., ex-chip) overvoltage protection devices, that protect the packaged chip against more severe (e.g., higher voltage) overvoltage events. Inasmuch as the on-chip and off-chip overvoltage protection devices are in electrical communication, the off-chip overvoltage protection device may be required to “protect” the on-chip overvoltage protection device. Off-chip overvoltage protection devices using discrete components are difficult to add during manufacture of the substrate. Moreover, on-chip protection is difficult to optimize across a complete system or subsystem. Examples of specifications for ESD testing include IEC 61000-4-2 and JESD22-A114E.

A printed circuit board, printed wiring board, or similar substrate (hereinafter also referred to as PCB) may be used to assemble, support, and connect electronic components. A PCB typically includes a substrate of dielectric material and one or more conductive leads to provide electrical conductivity among various attached components, chips, and the like. Typically, a pattern of metallic leads is plated (e.g., using printing technology such as silk-screening) onto the dielectric substrate to provide electrical connectivity. Alternatively a metallic layer (e.g., a layer of Cu, Ag, Au) is applied to the substrate and subsequently portions of the metallic layer are removed (e.g., etched) resulting in the desired pattern. Multiple layers of conductive patterns and/or dielectric materials may be disposed on a PCB. The layers may be connected using vias. Printed circuit boards including 14 or more layers are not uncommon.

A PCB is typically used for supporting and connecting various integrated electronic components, such as chips, packages, and other integrated devices. The PCB may also support and connect discrete components, such as resistors, capacitors, inductors, and the like, and provide connections between integrated and discrete components. The conductive patterns and/or layers in the PCB and other components or areas within electronic devices sometimes provide paths for conducting overvoltage events that could damage or otherwise negatively impact components.

Various structures, methods and devices exist in the prior art for providing overvoltage protection to electronic devices (e.g., discrete surge suppression components surface mounted to PCBs), but they generally exhibit a variety of limitations in manufacturability, performance, operational characteristics and cost. There is a need for improved overvoltage protection structures, methods and devices.

### BRIEF DESCRIPTION OF THE DRAWINGS

FIG. 1 is a simplified diagram of a system for designing integrated circuit devices using voltage switchable dielectric material (VSD material), according to an embodiment.

FIG. 2 illustrates a method for designing a device to accommodate electrical protective features that include the use of VSD material, under an embodiment.

FIG. 3 illustrates a system level figure for simulating a device in handling ESD and other electrical events, according to an embodiment.

FIG. 4 shows a circuit configuration that uses a VSDM component 404 in combination with an impedance element 420 to protect an electronic component 430 against ESD events, in accordance with an embodiment.

### DETAILED DESCRIPTION

Embodiments described herein provide for programmatic design or simulation of substrates carrying electrical elements to integrate an embedded ESD component as a protective feature. In particular, embedded ESD component may be incorporated into the design of a substrate device for the purpose of providing protection against transient electrical conditions, such as electrostatic discharge (ESD). The embedded ESD component can incorporate different kinds of protective material and components, including VSDM or a VSDM component, varistor material, silicon diode, metal oxide varistor, traneint voltage suppression (TVS), zener diodes, or any other ESD protection element(s) (or combinations thereof) that can be embedded inside a substrate.

Embodiments described recognize that simulation for electrostatic discharge (ESD) failures at a system level can be challenging. The simulations often require very large computational equipment and very long computation times. Often the results are difficult to interpret practically for pass/fail ESD criteria at the system level. One of the complications in accurate ESD simulation is creating models for various components on the PCB. Manufacturer available models are typically not defined for ESD currents and voltages. These components need to be re-characterized using transmission line pulsing so their response during an ESD event can be predicted.

Protection against ESD and other overvoltage events of a substrate device, electronic component and/or electronic device in accordance with various embodiments of the present invention may include incorporating a voltage switchable dielectric material (“VSD material” or “VSDM”) in the respective substrate and/or device. While those skilled in the art will recognize that overvoltage events encompass multiple events, ESD (electrostatic discharge) may be used herein to generally describe an overvoltage event.

A VSD material in accordance with various embodiments described herein is a material that exhibits nonlinear resistance as a function of voltage. While a VSD material exhibits nonlinear resistance, not all materials that exhibit nonlinear resistance are VSD materials. For example, a material for which resistance changes as a function of temperature but does not substantially change as a function of voltage would not be construed as a VSD material for purposes of embodiments of the present invention. In various embodiments, VSD materials exhibit nonlinear resistance variation as a function of voltage and additional operating parameters such as current, energy field density, light or other electromagnetic radiation input, and/or other similar parameters.

The variation of the resistance as a function of voltage exhibited by a VSD material includes a transition from a state of high resistance to a state of low resistance. This transition occurs at about a specific voltage value, which may be variously referred to as a “characteristic voltage,” “characteristic voltage level,” “switching voltage,” or “switching voltage level.” The characteristic voltage may differ for various formulations of VSD material, but is relatively stable for a given formulation. The characteristic voltage for a particular formulation may be a function of voltage coupled with additional parameters such as temperature and/or incident electromagnetic energy at various wavelengths including optical, infrared, UV, or microwave.

For a given VSD material composition, the characteristic voltage may be defined in terms of a corresponding “characteristic electric field” or “characteristic field” expressed in terms of voltage per unit of length (e.g., Volts per mil (V/mil), Volts per micrometer (V/um), etc.).

Unless otherwise expressly indicated, the term “structure of VSD material,” “VSD material structure” or “VSDM structure” is intended to refer to any volume of VSD material with specific physical dimensions that can perform an electrical switching function. Examples of a structure of VSD material include a layer of VSD material (whether disposed on a substrate or cured as a stand-alone layer), a volume of VSD material bounded between two or more electrodes, a volume of VSD material bounded by two or more insulative or semiconductor structures, or any other element or configuration of VSD material that can switch between substantially nonconductive and substantially conductive states in response to a sufficiently large voltage variation.

In one implementation, a VSD material structure may be produced by bounding a volume of a first VSD material with a first characteristic voltage between two other volumes of VSD materials with characteristic voltages that differ from the first characteristic voltages (the characteristic voltages of the two other volumes of VSD material may or may not be equal to each other).

In one implementation, a VSD material structure may be produced by bounding a volume of a VSD material with a first characteristic voltage between (a) a volume of VSD material with a different characteristic voltage, and (b) one or more electrodes, insulative structures, and/or semiconductor structures.

An example of a VSD material structure is a layer of VSD material disposed on a copper foil (but excluding the copper foil). A compound formation that comprises both the layer of VSD material and the copper foil may be denoted a “formation of VSDM.” More complex formations of VSDM are discussed below.

Another example of a VSD material structure is a coating, sheet, or other layout of VSD material, disposed as a horizontal layer in a PCB and bounded between two adjacent horizontal layers of the PCB (i.e., a horizontal layer above the VSD material structure, and a horizontal layer below the VSD material structure). A compound formation that comprises both this VSD material structure and the bounding two adjacent horizontal layers would be an example of a formation of VSDM.

Another example of a VSD material structure is a volume of VSD material disposed in a horizontal layer within a PCB and bounded between four structures disposed within the same horizontal layer of the PCB (e.g., four etched channels that delineate a rectangular VSD material structure) and between two electrodes disposed in the two adjacent horizontal layers (e.g., a conductive layer above and an insulative layer below). A compound formation that comprises both this VSD material structure and the bounding four structures and two electrodes would be an example of a formation of VSDM.

For a structure of VSD material with a known distance between two points where a voltage is applied (e.g., when a voltage is applied across the thickness of a layer of VSD material or across another gap of a VSD material structure), the characteristic voltage may be defined as specific voltage value (e.g., the characteristic voltage for this VSD material structure may be specified as a particular value in Volts).

Consequently, the characteristic voltage of a VSD material structure may be defined in terms of a characteristic electric field expressed as a voltage value per unit length, or as a characteristic voltage expressed as a specific voltage value when the VSD material is considered as a specific volume with certain known dimensional characteristics (e.g., a VSD material structure with a specific thickness across which voltage switching may occur). In various contexts, the descriptions in this patent may refer to characteristic fields or characteristic voltages of VSD materials in connection with various embodiments, and in each case the corresponding characteristic fields (in terms of Volts per unit length) or characteristic voltages (in terms of Volts) may be obtained through an appropriate conversion by taking into account the dimensional characteristics of the respective structures of VSD material. For example, for a uniform characteristic electric field produced within a VSD material structure, the characteristic voltage of that VSD material structure may be obtained by multiplying the characteristic field of that VSD material (in V/mil) by the corresponding gap across which switching will take place (in mils)). In a more general sense, for a non-uniform characteristic electric field produced within a VSD material structure, the characteristic voltage of that VSD material structure may be obtained by integrating the characteristic field of that VSD material throughout the gap across which switching will take place. In some embodiments, for some formulations of VSD materials and physical characteristics of the gaps across which switching may take place, the characteristic voltage of the VSD material across such gaps may not be directly or linearly correlated with the size of the respective gaps (e.g., in such embodiments, the respective characteristic voltages may be evaluated through direct measurements or through more complex simulations or approximations).

In general, the characteristic voltage of a VSD material structure may be a function of the amount, cross-sectional area, volume, depth, thickness, width and/or length of the VSD material structure that is disposed between the two points where the voltage is applied, and possibly also a function of the relative shape, geometry, density variation, and other analogous variables relating to the VSD material structure.

A VSD material is substantially non-conductive (i.e., substantially insulative) at voltages below the respective characteristic voltage level, in which case it behaves substantially as an insulator or dielectric. This state may be referred to as a substantially nonconductive or insulative state. Voltages below the characteristic voltage level of a VSD material may be referred to as low voltages (at least relative to voltages above the characteristic voltage level). In such operating regimes below the characteristic voltage level, a VSD material provided in embodiments of the current invention may also be construed as having attributes of a semiconductor, similar to semiconductor materials that are suitable to serve as substrates in semiconductor manufacturing processes. A VSD material in accordance with various embodiments may behave substantially as an insulator for both positive and negative voltages when the magnitude of the voltage is below the characteristic voltage level.

At voltages higher than its characteristic voltage level, a VSD material, in accordance with various embodiments of the present invention, behaves substantially as a conductor by having substantially no electric resistance, or relatively low resistance. This may be referred to as a substantially conductive state. Voltage above the characteristic voltage level may be referred to as high voltage. The VSD material is conductive or substantially conductive for both positive and negative voltages when the magnitude of the voltage is above the characteristic voltage level. The characteristic voltage may be either positive or negative, depending on the polarity of the voltage being applied. When a VSD material becomes substantially conductive in response to a voltage that exceeds its characteristic voltage, the VSD material could be said to “switch on.” When a VSD material becomes substantially non-conductive after removing a voltage that exceeds its characteristic voltage, the VSD material could be said to “switch off.” When a VSD material switches on or off, the VSD material could be simply said to “switch.”

In an ideal model, the operation of a VSD material provided in various embodiments of the present invention is approximated as having infinite resistance at voltages below the characteristic voltage, and zero resistance at voltages above the characteristic voltage. In normal operating conditions, however, such VSD materials typically have high, but finite resistance at voltages below the characteristic voltage, and low, but nonzero resistance at voltages above the characteristic voltage. As an example, for a particular VSD material, the ratio of the resistance at low voltage to the resistance at high voltage may be expected to approach a large value (e.g., in the range of 10̂3, 10̂6, 10̂9, 10̂12, or higher). In an ideal model, this ratio may be approximated as infinite, or otherwise very high.

The VSD material provided in various embodiments of the present invention exhibits high repeatability (i.e., reversibility) in its operation in both the low voltage regimes and the high voltage regimes. In some embodiments, the VSD material behaves substantially as an insulator or dielectric (i.e., is substantially nonconductive and exhibits a very high or substantially infinite electric resistance) at voltages below the characteristic voltage level. The VSD material then switches to become substantially conductive when operated at voltages above the characteristic voltage level, then becomes again substantially an insulator or dielectric at voltages below the characteristic voltage. The VSD material can continue to alternate between these two operational states an indefinite number of times if the input voltage levels transition between voltages below the characteristic voltage and above the characteristic voltage. While transitioning between these two operational states, a VSD material may experience a certain level of hysteresis, which may after, to a certain extent, the characteristic voltage level, the switching response time, or other operational characteristics of the VSD material.

The transition between the first (lower) voltage regime, when the VSD material is substantially insulative, and the second (higher) voltage regime when the VSD material is substantially conductive, in accordance with embodiments of the current invention, is substantially predictable and is expected to be generally confined to a limited envelope of signal amplitudes and a limited range of switching times. In an ideal model, the time that it takes a VSD material to transition from a state of substantial insulation to a state of substantial conductance in response to an input step function signal that rises above the characteristic voltage may be approximated as zero. That is, the transition may be approximated as substantially instantaneous. Similarly, in an ideal model, the time that it takes a VSD material to transition from a state of substantial conductance to a state of substantial non-conductance in response to an input step function signal that drops below the characteristic voltage may be approximated as zero. This reverse transition may also be approximated to be substantially instantaneous. Under normal operating conditions, however, both of these transition times for VSD materials are non-zero. In general, such transition times are small, and are preferably as small as possible (e.g., in the range of about 10̂-6 seconds, 10̂-9 seconds, 10̂-12 seconds, or smaller). Further details of the formulations and characteristics of VSD materials are disclosed in U.S. Pat. No. 7,872,251, issued on Jan. 18, 2011 to Kosowsky, et al., and titled “Formulations for Voltage Switchable Dielectric Material Having a Stepped Voltage Response and Methods for Making the Same,” which is hereby incorporated by reference in its entirety.

When in a substantially conductive state, a VSD material in accordance with various embodiments may direct an electrical signal to ground or to another predetermined point within the respective circuit, substrate or electronic device to protect an electronic component. In various embodiments, the predetermined point is a ground, virtual ground, shield, safety ground, and the like. Examples of electronic components that may be operated with and/or protected by VSD materials in accordance with various embodiments of the present invention include (a) circuit element, circuit structure, surface mounted electric component (e.g., resistors, capacitors, inductors), PCB or other circuit board, electronic device, electronic subsystem, electronic system, (b) any other electric, magnetic, micro-electromechanical structure (MEMS) or similar element, structure, component, system and/or device, (c) any other unit that processes or transmits data and operates using electric signals or may be damaged by electric signals, and (d) any combination of the foregoing identified in (a), (b) and/or (c) above.

In general, a VSD material may have a limited ability to conduct current or otherwise operate in the presence of high signal voltages, current intensities, and energy or power levels before being damaged, possibly irreversibly damaged. Additionally, a VSD material may also be damaged if an electric signal that is normally within operating specifications persists for too long (e.g., the VSD material may heat up while conducting such signals and eventually break down). For example, a VSD material may be able to function normally when exposed to an input signal with a voltage level of 10 KV that lasts less than 100 nanoseconds, but may be damaged if that signal continues to be applied for more than a few milliseconds. The ability of a VSD material to tolerate high levels of voltage, current, power or energy before becoming damaged may depend on various factors, such as the particular composition of the VSD material, the specific characteristics of a corresponding VSD material structure (e.g., a VSD material structure with larger physical dimensions may be able to conduct higher current densities), the corresponding circuit architecture, the presence of other ESD protective components, and the characteristics of the device in which the VSD material is incorporated.

VSD materials in accordance with various embodiments are polymer composites, and may include particulate materials such as metals, semiconductors, ceramics, and the like. Examples of various compositions of VSD materials that may be used in accordance with various embodiments are described in, for example, U.S. patent application Ser. No. 12/953,309 filed on Nov. 23, 2010 and titled “Formulations for Voltage Switchable Dielectric Materials Having a Stepped Voltage Response and Methods for Making the Same,”, U.S. patent application Ser. No. 12/832,040 filed on Jul. 7, 2010 and titled “Light-Emitting Diode Device For Voltage Switchable Dielectric Material Having High Aspect Ratio Particles,” and U.S. patent application Ser. No. 12/717,102 filed on Mar. 3, 2010 and titled “Voltage Switchable Dielectric Material Having High Aspect Ratio Particles,” and U.S. Pat. No. 7,981,325 issued on Jul. 19, 2011 and titled “Electronic Device For Voltage Switchable Dielectric Material Having High Aspect Ratio Particles.”

VSD materials in accordance with various embodiments may include a matrix material and one or more types of organic and/or inorganic particles dispersed within the matrix material.

Examples of matrix materials incorporated in VSD materials, in accordance with various embodiments, may include organic polymers, such as silicone polymer, phenolic resin, epoxy (e.g., EPON Resin 828, a difunctional bisphenol A/epichlorohydrin derived liquid epoxy resin), polyurethane, poly(meth)acrylate, polyamide, polyester, polycarbonate, polyacrylamides, polyimide, polyethylene, polypropylene, polyphenylene oxide, polysulphone, ceramer (a solgel/polymer composite), and polyphenylene sulfone. Other examples of such matrix materials include inorganic polymers, such as siloxane, and polyphosphazines.

Examples of particles incorporated in VSD materials, in accordance with various embodiments, may include conductive and/or semiconductive materials including copper, aluminum, nickel, silver, gold, titanium, stainless steel, chrome, other metal alloys, T, Si, NiO, SiC, ZnO, BN, C (including in the form of diamond, nanotubes, and/or fullerenes), ZnS, Bi₂O₃, Fe₂O₃, CeO₂, TiO₂, AIN, and compounds of indium diselenide. In some embodiments, TiO₂ can be undoped or doped, for example with WO3, where doping may include a surface coating. Such particles may have a shape ranging from spherical to highly elongated, including high aspect ratio particles, including carbon nanotubes (single walled and/or mufti-walled), fullerenes, metal nanorods, or metal nanowires. Examples of materials that form nanorods and/or nanowires include boron nitride, antimony in oxide, titanium dioxide, silver, copper, tin, and gold.

The aspect ratio of some particles incorporated in VSD materials in accordance with various embodiments may have aspect ratios in excess of 3:1, 10:1, 100:1, and 1000:1. Materials with higher aspect ratios are sometimes called “High Aspect Ratio” particles or “HAR” particles. Carbon nanotubes are examples of super HAR particles, with aspect ratios of an order of 1000:1 and more. Materials with lesser aspect ratios that may be incorporated in VSD materials in various embodiments include carbon black (L/D of any order of 10:1) particles, and carbon fiber (L/D of an order of 100:1) particles.

The particles incorporated in VSD materials, in accordance with various embodiments, may have various sizes, including some nanoscale particles characterized by a smallest dimension equal to 500 nm or smaller, or even smaller (e.g., particles for which a smallest dimension is less than 100 nm or 50 nm).

The particles incorporated in VSD materials in accordance with various embodiments may include organic material. Incorporating organic materials within a VSD material may provide to the VSD material improved coefficients of thermal expansion and thermal conductivity, better dielectric constant, enhanced fracture toughness, better compression strength, and improved ability to adhere to metals. Examples of organic semiconductors that may be incorporated in VSD materials in various embodiments include forms of carbon such as electrically semiconducting carbon nanotubes and fullerenes (e.g., C60 and C70). Fullerenes and nanotubes can be modified, in some embodiments, to be functionalized to include a covalently bonded chemical group or moiety. Other examples of organic semiconductors that may be incorporated in VSD materials in various embodiments include poly-3-hexylthiophene, polythiophene, polyacteylene, poly (3,4-ethylenedioxythiophene), poly (styrenesulfonate), pentacene, (8-hydroxyquinolinolato) aluminum (III), and N,N′-di-[(naphthalenyl)-N,N′diphenyl]-1,1′-biphenyl-4 and 4′-diamine [NPD]. Additionally, organic semiconductors can be derived from the monomers, oligomers, and polymers of thiophene, analine, phenylene, vinylene, fluorene, naphthalene, pyrrole, acetylene, carbazole, pyrrolidone, cyano materials, anthracene, pentacene, rubrene, perylene, and oxadizole. Some of these organic materials may be photo-active organic materials, such as polythiophene.

In reference to distribution of particles within a VSD material polymeric composition, distributing particles “substantially uniformly” means that on the average the respective particles are distributed uniformly and/or randomly within the material, but it is certainly possible that in limited subportions of the polymeric composition nonuniform and/or non-random agglomerations of such particles may occur. Indeed, even after extensive mixing, there will normally be a nonzero statistical probability with which such agglomerations of particles may occur within limited volumes within the VSD material, and this could happen though all phases of the VSD material, including when the VSD material is in a liquid or semi-liquid form before application to a substrate, after it is disposed on a substrate (for example through coating), and/or after it is cured (whether on a substrate or otherwise). Overall, however, when considering the whole quantity of VSD material (or a sufficiently large subportion of such VSD material) the respective particles may be deemed to be distributed uniformly and/or randomly within the mixture, and in modeling the behavior of the respective VSD material, the particles may be modeled as being distributed uniformly and/or randomly.

In various embodiments, the characteristic voltage of a VSD material structure disposed between two electrodes contacting the VSD material decreases as the distance between the electrodes decreases. The distance between the electrodes across which the VSD material may switch between substantially conductive and substantially nonconductive states in response to voltage variations that are sufficiently large could be denoted a “thickness,” “effective thickness,” “gap,” “switching gap,” or “effective gap.” The effective gap for a VSD material structure could be considered to be horizontal if the two electrodes are disposed in a substantially horizontal plane, or could be considered to be vertical if the two electrodes are disposed in different vertical planes and/or if the voltage switching takes place predominantly in a vertical direction.

In general, a “substrate device” that may be protected by a VSDM formation against ESD or other overvoltage events, or into which a VSDM formation may be incorporated, means any solid medium to which a substance or structure is applied or otherwise attached. For simplicity, a substrate device may sometimes be denoted a “substrate.”

In some embodiments, the term substrate may refer to a slice of semiconductor material such as silicon, metal oxide or gallium arsenide (GaAs) that serves as the foundation for the construction of components such as transistors and integrated circuits (IC s). In the manufacture of an IC, the substrate material is cut or formed into wafers, on which the individual electronic components are etched, deposited or fabricated.

In some embodiments, the term substrate may refer to a first (1st) level package. A first level package may comprise one or more materials, disposed in one or more layers. Examples of materials that may be included in a first level package include any metal, ceramic, glass, silicon, polymeric material (e.g., FR4, FR5, BT), or any combination of the foregoing. A first level package may also comprise electronic circuitry that serves as the foundation for connecting single or multiple integrated circuits (e.g., examples of such multiple integrated circuits include a die, chip or device) using an interconnecting material. Examples of such interconnecting materials include solder, metal plating, wire or tab bonding, or other interconnection materials. An interconnecting material may adhere to a metal pad patterned onto the substrate which connects the integrated circuits to the substrate. In such configurations, the interconnection between an integrated circuit and the substrate is referred to as first (1st) level interconnect, and the substrate is then commonly referred to as 1st level package, or 1st level interconnect package, or 1st level substrate package. A first level package can also be referred to as a printed wiring board (PWB) or printed circuit board (PCB). A 1st level interconnect package, in various applications, may have metal pads patterned on the top side or bottom side which are used to interconnect the 1st level package to a second (2nd) level package.

In some embodiments, the term substrate may refer to a second (2nd) level package. A second level package may have the same structure, architecture and functionality as described above for a first level package, but is disposed as a different layer in a mufti-layer stack that also includes a first layer package.

In various embodiments, examples of substrates may include a PCB, any single layer or set of multiple layers of a PCB, the package of a semiconductor device (e.g., ball grid array (BGA), a land grid array (LGA), a pin grid array), an LED substrate, an integrated circuit (IC) substrate, an interposer or any other platform that connects two or more electronic components, devices or substrates (where such connection may be vertical and/or horizontal), any other stacked packaging or die format (e.g., an interposer, a wafer-level package, a package-in-package, a system-in-package, or any other stacked combination of at least two packages, dies or substrates), or any other substrate to which a VSDM formation can be attached or within which a VSDM formation may be incorporated.

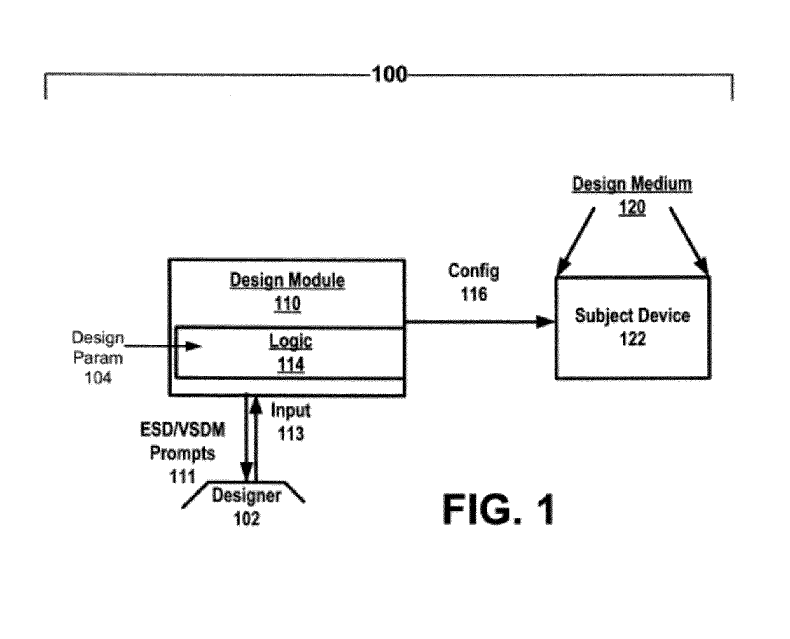

FIG. 1 is a simplified diagram of a system for designing integrated circuit devices using an embedded ESD component, according to one or more embodiments. An embedded ESD component includes any VSDM component, varistor material, silicon diode, metal oxide varistor, traneint voltage suppression (TVS), zener diodes, or any other ESD protection element(s) (or combinations thereof) that can be embedded inside a substrate. A system 100 for designing electronic devices may be implemented in the context of creating a new electronic device (such as an integrated circuit device or printed circuit board) in combination with a manufacturing or production process, and/or simulating or testing operations of a layout or construct of the device. Examples of devices that may be produced and/or simulated with embodiments described herein include printed circuit boards, wafers and chips, semiconductor packaging substrate, display devices and backplanes, and other circuit devices or hardware (collectively “subject device”).

With reference to an embodiment of FIG. 1, system 100 may include a design module 110 for creating a design layout for the subject device 122. A designer 102 may interface and operate the design module 110 to specify or configure layout and/or design information of the subject device 122. In one implementation, design module 110 corresponds to a software design application that can be operated by a designer through use of a computer terminal. For example, the software design application may correspond to an electronic design automation (EDA) package, such as manufactured by Cadence System designs, Inc. or Mentor Graphics.

The designer 102 may implement various kinds of information in the design module 110, including circuit layout, components, design parameters, and/or performance criteria. These specifications enable the subject device 122 to be designed, simulated and optionally produced in a design medium 120. As such, the design medium 120 may be virtual or simulated, or alternatively actual or real. The simulated or virtual design medium may correspond to a computer-implemented environment that enables, for example, simulation or testing of a subject device 122. As embodiments such as described pertain to design or simulation, device 122 may include data representations of actual physical devices. A real design medium may include the use of manufacturing, production and/or other implementation equipment and processes for implementing designs generated from module 110 onto the subject device 122 production.

In one embodiment, design module 110 includes logic 114 for determining and automating selection and use of an ESD component, such as a VSD component, onto or within a substrate device. In some variations, the design module includes logic for application of VSD material onto or within the subject device 122. Logic 114 may be responsive to design and/or performance parameters 104 specified by the designer 102. The logic 114 may, based on designer or programmatic input, provide for determinations that include (i) determining whether a protective ESD component is to be used, (ii) determining whether an embdedded ESD component is to be used, (iii) determining a type of performance requirement of the embedded ESD component, which may optionally include determining parameters or requirements for the VSD material.

In one embodiment, an initial determination is made as to whether a board or base element of the subject device 122 is to include an embedded ESD component. If the embedded ESD component is to be included, the application logic 114 may use various prompts and/or design (“configurations 116”) specifications to determine how the embedded ESD component is to be positioned or included on the subject device 122.

In an embodiment, the design module 110 may provide an initial prompt 111 or interface to enable the designer 102 to elect to include the embedded ESD component, as well as specify the type, components and/or location of the embedded ESD component. The module 110 may also provide one or more subsequent prompts 111 or interfaces to determine specifics about the device under design, including tolerance levels of individual elements on the substrate, spatial constraints, and device type. In one embodiment, all of the information used in determining a configuration for the VSD material is inferred. For example, user input pertaining to voltage tolerances of individual components or elements of a device under design may be used to programmatically determine at least some of the embedded ESD component/configuration information, such as, for example, the type of VSD material used and one or more spatial characteristics of the VSD material (e.g. gap separation or shape, as described below). In another embodiment, some of the embedded ESD component configurations may be determined from user-input that directly pertains to, for example, the use of VSD material. The responses to the prompts 111 may be provided by inputs 113 of the designer 102. The additional ESD component configurations 116 may, for example, specify the location of the embedded ESD component, the components of the embedded ESD component (e.g., material composition of the VSD material or other ESD-protective element that affects the performance of the embedded ESD component) in the presence of an ESD event. Under one embodiment, the presence and specification of the embedded ESD component may be tied to the ESD characteristics desired from the subject device 122.

The architecture and operation of exemplary circuits that may utilize switching VSDM formations for ESD protection are disclosed in U.S. application Ser. No. 13/096,860 and in application Ser. No. 13/115,068. Each of the Ser. No. 13/096,860 and Ser. No. 13/115,068 applications is incorporated herein by reference in its entirety.

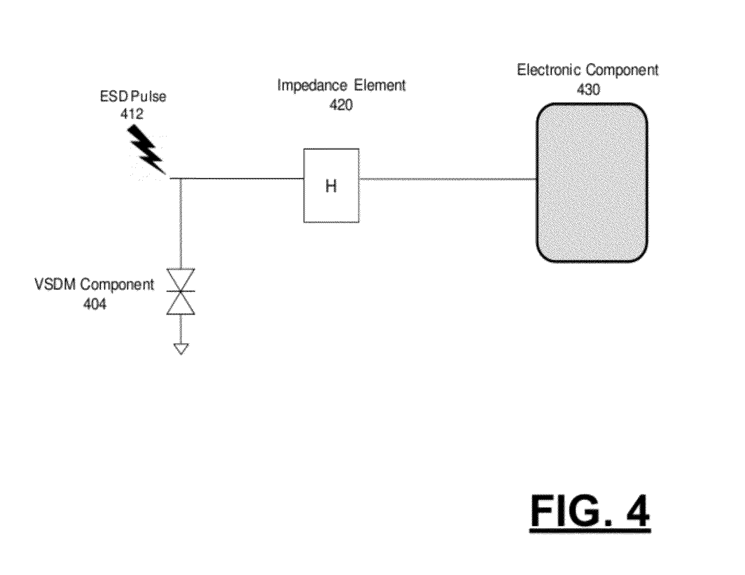

FIG. 4 shows a circuit configuration that uses an embedded ESD component in combination with one or more impedance elements to provide protection to an electronic component, according to one or more embodiments. More specifically, in an embodiment described by FIG. 4, a VSD component 404 is provided as the embedded ESD component. In variations, other forms of embedded ESD components may be used.

In general, the term “VSDM component” encompasses any switching VSDM formation that may be adapted to provide ESD protection, including horizontal switching VSDM formations, vertical switching VSDM formations and dual switching VSDM formations disclosed in various embodiments in U.S. Patent Application No. 61/537,490 titled “Vertical Switching Formations for ESD Protection,” which is hereby incorporated by reference in its entirety. The term “VSDM component” may be more convenient when considering the operation and functionality of a switching VSDM formation as perceived from a system design, simulation and/or manufacturing standpoint. A VSDM component may be described, emulated, simulated and modeled like other components (whether embedded or discrete) in an electric circuit.

In the embodiment of FIG. 4, the VSDM component 404 may be incorporated inside a substrate or may otherwise be connected to a substrate, including as discussed in U.S. Patent Application No. 61/537,490. Examples of such substrates include any PCB, any single layer or set of multiple layers of a PCB, the package of a semiconductor device, an LED substrate, an integrated circuit (IC) substrate, an interposer or any other platform that connects two or more electronic components, devices or substrates (where such connection may be vertical and/or horizontal), any other stacked packaging or die format (e.g., an interposer, a wafer-level package, a package-in-package, a system-in-package, or any other stacked combination of at least two packages, dies or substrates), or any other substrate to which a VSDM formation can be attached or within which a VSDM formation may be incorporated.

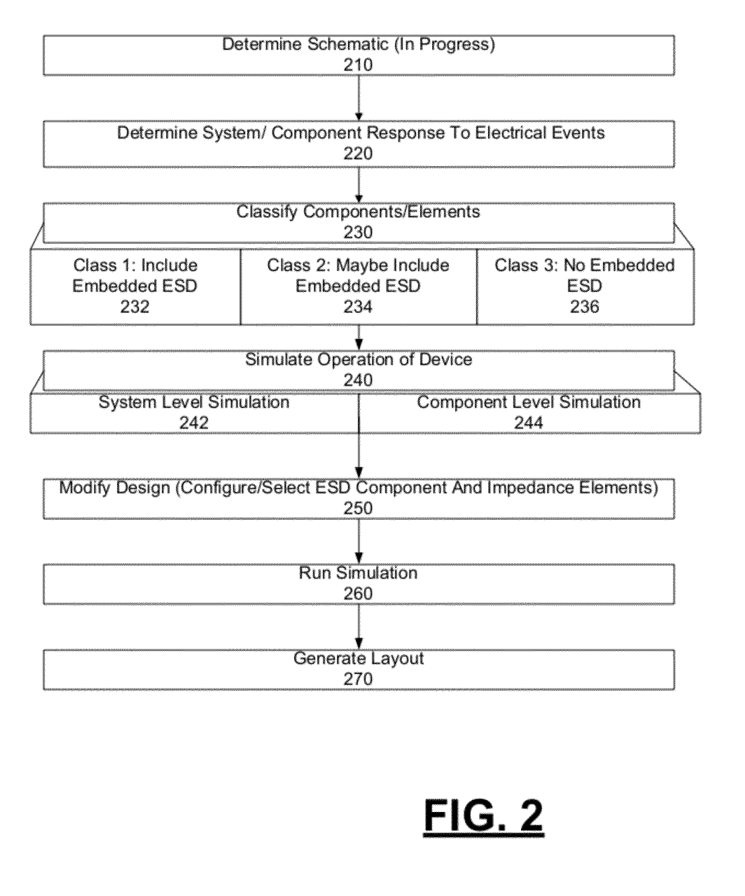

In an embodiment, the VSDM component 404 is provided in combination with an impedance element 420 to protect an electronic component 430 against ESD events, in accordance with an embodiment. The circuit configuration shown in the embodiment of FIG. 4 is architecturally and operationally similar to some of the exemplary circuits discussed in U.S. application Ser. Nos. 13/096,860 and 13/115,068 (e.g., the circuit discussed in connection with the embodiment of FIG. 2 in U.S. application Ser. Nos. 13/096,860).

In the embodiment of FIG. 4, the VSDM component 404 is shown as being connected to a ground. This ground could be a ground plane inside a substrate, or any other conductive structure that is connected directly or indirectly to a ground signal level. In an alternative implementation, the VSDM component 404 may be connected to a different point in an electric circuit or inside an electronic device (e.g., to any predetermined net, potential or other reference or point to which an ESD pulse may be directed in whole or in part or from which an electrical signal may be received). In various embodiments, the VSDM component 404 is connected to a ground, virtual ground, a shield, a safety ground, a package shell, a conductive line, a direct or indirect connection to a component, a point along any other electrical path, or any combination of the foregoing. The connection of the VSDM component 404 to a ground or to another reference point may be made directly, or through one or more circuit elements.

In the embodiment of FIG. 4, an impedance element 420 is disposed between the VSDM component 404 and an electronic component 430 to be protected against ESD events.

In one embodiment, the impedance element 420 is a resistor, in which case the impedance H of the impedance element 420 is substantially resistive and does not include any significant capacitive or inductive components. In other embodiments, the impedance element 420 could have a more complex impedance profile, as further discussed below and in U.S. application Ser. Nos. 13/096,860 and 13/115,068.

In various embodiments, an impedance element, such as impedance element 420, consists of one or more circuit elements, performs the function of one or more circuit elements, or comprises one or more circuit elements. In various embodiments, the impedance element 420 may include one or more resistors, one or more inductors, one or more capacitors, one or more ferroic circuit elements (e.g., an embedded ferroic circuit element that may or may not comprise VSD material), one or more diodes, one or more transistors, one or more filters (e.g., various combinations of one or more low-pass, band-pass and high-pass filters or filter stages), any other passive or active circuit elements or electronic components, any layered interconnect with a negligible impedance, any layered interconnect with a non-negligible impedance (e.g., a layer of high dielectric material), any electrode or other conductive structure with a non-negligible impedance, and/or any combination of the foregoing.

In various embodiments, an impedance element, such as impedance element 420, may be embedded in a VSDM component (such as VSDM component 404), or may be embedded in the same substrate in which the VSDM component 404 is incorporated. In one embodiment, an impedance element, such as impedance element 420, may be surface-attached to the same substrate in which the VSDM component 404 is incorporated. In one embodiment, an impedance element, such as impedance element 420, may be incorporated in a different electronic device that is in electrical contact with the substrate in which the VSDM component 404 is incorporated (e.g., the VSDM component 404 may be incorporated in a connector that is attached to an electronic device that comprises the impedance element). In one embodiment, an impedance element, such as impedance element 420, is comprised in the packaging of the electronic component 430, or is otherwise attached to or incorporated into a substrate that is in physical contact or in electrical communication with the electronic component 430.

From an operational standpoint, in the embodiment of FIG. 4, the impedance element 420 is designed to help protect the electronic component 430 by attenuating or otherwise modifying in whole or in part a signal that propagates towards the electronic component 430 in response to the ESD pulse 412. Upon occurrence of the ESD pulse 412, the VSDM component 404 switches to a substantially conductive state and redirects at least a first portion of the ESD pulse 412 to the ground shown in FIG. 4 (or to another point), therefore attenuating the signal produced in response to ESD pulse 412 that would otherwise propagate to the electronic component 430. In this configuration, an attenuated second portion of the ESD pulse 412 may reach the impedance element 420, rather than the full ESD pulse 412. By redirecting at least a portion of the ESD pulse 412 to the ground, the VSDM component 404 prevents that redirected portion of the ESD pulse 412 from reaching the electronic component 430, thus, providing at least partial ESD protection to the electronic component 430.

In the embodiment of FIG. 4, the signal that is still transmitted towards the electronic component 430 in response to the ESD pulse 412 is intercepted by the impedance element 420. The impedance element 420 may be designed to further attenuate this signal (e.g., reduce its voltage and/or current amplitude), or to otherwise modify it (e.g., alter its frequency spectrum). As a result, the electronic component 430 receives a smaller portion of the ESD pulse 412 and is protected against ESD damage.

In some embodiments, the signal that is transmitted to the electronic component 430 experiences a voltage drop across the impedance element 420. By controlling this voltage drop (e.g., through appropriate design specifications), the voltage and current received at the electronic component 430 may be decreased to non-damaging or otherwise predetermined levels.

In general, the impedance element 420 may be designed to have a transfer function that attenuates or suppresses some or all of the electrical or frequency characteristics of the signal propagating towards the electronic component 430. Examples of such characteristics that can be attenuated or suppressed by the electronic component 430 in accordance with embodiments include voltage, current, frequency and/or bandwidth (e.g., an expected frequency spectrum), time value, and/or pulse shape.

In the embodiment of FIG. 4, the impedance element 420 may be configured to temporarily block the ESD pulse 412 while the VSDM component 404 switches to its substantially conductive state. In some embodiments, the ESD pulse 412 has a leading edge that rises rapidly. While the VSDM component 404 may be configured to switch fast, the response time of VSD materials is generally subject to a nonzero time delay. The leading edge of some ESD pulses may rise faster than the response time of the VSDM component 404. Consequently, the voltage generated by the ESD pulse 412 could momentarily exceed the damage threshold of the electronic component 430. The impedance element 420 may include circuit elements, such as a low pass filter, configured to block high frequency components included in fast rising pulses. In various embodiments, the impedance element 420 blocks a rising pulse when it is at a voltage level that is less than the characteristic voltage of the VSDM component 404. To achieve this, the impedance element 420 may be configured to suppress the ESD pulse in whole or in part at least temporarily before the VSDM component 404 begins switching. As a result, the impedance element 420 could block one or more characteristics or components of the ESD pulse 412 (e.g., the rising edge of a pulse in the ESD pulse 412) during the time it takes for the VSDM component 404 to switch from its substantially insulating state to its substantially conductive state.

In various embodiments, an impedance element, such as impedance element 420, includes a voltage or current amplitude and/or frequency filter. For example, the impedance element 420 may be configured as a high pass filter, a low pass filter, or a band pass filter. The impedance element 420 may transmit a first voltage or current (e.g., associated with normal operation of electronic component 430) with no, or substantially no, distortion or attenuation, and may block in whole or in part a second voltage or current associated with abnormal events (e.g., an ESD event). For example, the impedance element 420 may be configured as a low pass filter to transmit to the electronic component 430 a signal at normal or design frequencies. Upon occurrence of an ESD pulse 412 including high frequency components, the impedance element 420 may block in whole or in part the high frequency components of the ESD pulse 412. The full or partial blocking of the ESD pulse 412 may provide the VSDM component 404 sufficient time to respond to the high voltage regime and switch to a substantially conductive state before the electronic component 430 may be damaged.

The impedance of the impedance element 420 may be selected to pass to the electronic component 430 signals at voltages that would not normally damage electronic component 430 (e.g., voltages below 40 volts, below 24 volts, below 12 volts, below 5 volts, and/or below 3 volts, depending upon the respective chip or device specifications). The impedance of the impedance element 420 may be further selected to block ESD pulse 412 at high and/or potentially damaging voltages (e.g., above 10 volts, above 100 volts, above 1000 volts, above 10 kV, or even higher) depending upon the chip or device specifications of the electronic component 430 and/or frequency components of the ESD pulse 412.

In one embodiment, the impedance element 420 may be implemented using a ferroic circuit element that includes a conductive structure embedded at least partially within a ferroic material. A ferroic circuit element comprising ferroic VSD material and suitable for such implementations was disclosed in U.S. patent application Ser. NO. 13/115,068. In various embodiments, the impedance element 420 may be implemented as an embedded ferroic inductor, embedded ferroic VSD material inductor, embedded ferroic capacitor, embedded ferroic VSD material capacitor, or as any other embedded ferroic circuit element or embedded ferroic VSD material circuit element.

In some embodiments, a VSDM component (such as the VSDM component 404) is added to a circuit or network together with one or more impedance elements (such as the impedance element 420) to protect a circuit element, electronic component, or other subsystem. In some implementations, however, the circuit element, electronic component, or other subsystem to be protected already incorporates an impedance element (or such an impedance element may otherwise exist within the respective electronic device), and a decision may be made in accordance with various embodiments to utilize that incorporated or existing impedance element, therefore avoiding the need to add an additional impedance element. It may be advantageous in certain embodiments to avoid adding one or more impedance elements to the extent that impedance elements already included in the design of the electronic device may be utilized to support the operation of VSDM components (e.g., such already included impedance elements could be used to perform the functionality discussed in connection with the impedance element 420).

FIG. 2 illustrates a method for designing a device to accommodate electrical protective features that include the use of an embedded ESD component, under an embodiment.

Design material for the design of an electrical system in an electronic device is compiled for analysis (210). The design material can include, for example, a schematic, a component or material list for the design, or a Bill of Material (BOM). Examples of electronic devices include mobile computing devices or handsets (e.g., cellular telephony/messaging devices or smart-phones), tablets, media players (e.g., iPOD manufactured by APPLE INC.), digital cameras, GPS devices, portable memory devices etc. Numerous devices and form factors can be designed in accordance with a method such as described with FIG. 2.

An initial design of the electrical system is evaluated to determine a system and/or component level response to certain electrical events (220). The evaluation may be performed programmatically and/or manually, using design materials such as the schematic and/or BOM. Thus, the evaluation may include component or material design. The evaluation can include identifying potential or expected points of sensitivity to ESD or other unwanted electrical activity. In one embodiment, potential or likely ESD inlets are identified in the preliminary design of the device. A baseline simulation may be implemented (e.g., one without protective elements such as VSD components, or one that uses Human Body Model (HBM) assumptions) in order to determine where potential points of failure exist when electrical events occur.

For example, an embodiment provides for identifying ESD inlets or failure points on a whole device (e.g. cell phone, other consumer electronic device) through simulation. The device may be simulated for an ESD pulse through any potential ESD propagation path, including through any common ESD inlet such as a keypad, headset connector, power supply connector, or data port. The resulting handling of the ESD pulse in the design is determined by measuring (or modeling) currents through each active and/or passive circuit element, component, circuit, network, or other subsystem. Currents, voltages, signal metrics (e.g., pulse shapes, signal envelopes, signal-to-noise ratios, intermodulation effects, signal interference, and/or any other signal integrity or performance factors) are compared against values known or expected to be acceptable (e.g., against specifications provided for components to be protected) to define ESD failure locations.

The likely inlets for the ESD event can correspond to, for example, locations for connector inputs or outputs, data ports, power supply connectors, headset connectors, buttons, antennas or antenna pads, and touchscreens. One result of the evaluation includes identifying those components of the electrical system (e.g., electrical component or integrated circuit) that are likely optimal for protection using VSD components. Another result of the evaluation includes identifying those components which are not likely good candidates for protection with VSD components.

In an embodiment, the circuit elements and/or electrical components of the system under design can be classified (230). A first classification may identify a first class of circuit elements and/or electrical components for which the use of one or more embedded ESD components and/or impedance elements will likely provide a direct and tangible benefit (232). More specifically, use of such circuit elements and/or electrical components with one or more embedded ESD components and/or impedance elements may satisfy conditions that include a determination that (i) the circuit element and/or electrical component would likely receive significant protection against unwanted electrical events such as ESD with use of embedded ESD components and/or impedance elements; and/or (ii) the use of one or more embedded ESD components and/or impedance elements with the particular circuit element and/or electrical component avoiding unwanted detrimental consequences, such as potentially undesirable parasitic capacitance, negative performance impact, or significant increase as to cost.

A third classification may identify a third class of circuit elements and/or electrical components for which the use of embedded ESD components and/or impedance elements is unwanted or otherwise undesired (236) based on certain conditions. Such conditions may include a determination that (i) circuit elements and/or electrical components may receive no significant protective benefit from the use of an ESD component (e.g., elements that are sensitive to voltage levels that are below the voltage levels where ESD components are effective, such as below the characteristic level of VSD material comprising the embedded ESD component), and/or (ii) some circuit elements and/or electrical components would be likely to experience detrimental or unwanted consequences stemming from the element or component connecting to an ESD component and/or impedance element. For example, one or more ESD components or impedance elements may be arranged in a manner that would introduce parasitic capacitance that would otherwise significantly impact the performance of the particular circuit or element. For example, in some implementations in which VSD material is used, the parasitic capacitance may be estimated as being in a range of 300-800fF, based on arrangements in which the vias or other interconnects are used to connect to the VSD material, and such capacitance may be too high for certain applications.

The use of, for example, VSDM components and/or impedance elements may also be unwanted in connection with RF circuits and components, which can be particularly susceptible to additional capacitance, resistance or inductance. For example, a VSDM component or impedance element may introduce capacitance which can affect the signal integrity on the RF signal path. Consequently, for various circuit elements, electronic components, circuits, networks, or subsystems, the use of VSD material may be limited (e.g., single layer of VSD material near an RF circuit) or may be completely avoided.

A second classification may identify a second class of circuit elements and/or electrical components for which the use of one or more ESD components and/or impedance elements has a measured benefit, but also a significant detriment (234). For example, for a VSD component, the circuit elements and/or electrical components of the third class may be protectable with VSD material, but also have potential for detrimental impact on performance or functionality as a result of VSD material. Alternatively, the circuit elements and/or electrical components of this classification may only have indirect or reduced protective benefits from the use of VSD material.

In one embodiment, using conditions and criteria such as those discussed above, a classification analysis divides electronic components and/or circuit elements in three classes as follows: (i) class 1: circuit elements and/or electronic components that must or should be protected against ESD events with ESD components and/or impedance elements; (ii) class 2: circuit elements and/or electronic components that may optionally be protected against ESD events with ESD components and/or impedance elements; and (iii) class 3: circuit elements and/or electronic components that must not, or should not be protected against ESD events with ESD components and/or impedance elements.

In an embodiment, simulation operations may be performed for the device under design (240). The simulation operations may be performed both with and without ESD components and/or impedance elements. The simulation operations may include system level simulation operations (242) and component level (or component network level) simulation operations (244). The simulations may alternate with, for example, use of different types of ESD components (e.g., different types of VSD material, such as with different composition and electrical characteristics) that are in use. Simulation operations may also include simulation of electrical events that occur at different locations of the device, particularly at anticipated inlets.

The results of the simulation can include determining the system level criteria for protecting the device. For example, the system level criteria can include enabling the device to handle large peak currents and large amounts of energy when ESD events occur. According to embodiments, the embedded ESD component (e.g., embedded layer of VSD material) may be positioned and configured to handle at least some portion of the current or energy generated through a system level electrical event.

Additionally, the results of the simulation can include determining component level criteria for protecting specific components or combination of components on the device. For example, on a component level, integrated circuit criteria can include, protecting the circuit against low peak currents (e.g. 1.5 A at 2 kV) and low total energy (<1 μJ tolerated by typical IC). Protection of circuit elements can be achieved through use of the embedded ESD component (e.g., VSD component or layer of VSD material), as well as through mechanisms such as protection circuits, including reversed biased diodes that extend between both trace and voltage supply, and trace and ground. Transistor level criteria can also be determined for protecting transistor-level components on the device. Transistor criteria can include, for example, consideration for transistor material type, technology node, failure mechanism, peak voltage, and IR heating (based on total heating).

Accordingly, results of the simulation operations can include determination of currents, frequency responses, behavior and other relevant operational and performance characteristics of various circuit elements. For example, these and other determinations may be made for some or all circuit elements, chips, electric circuits, nets, subsystems and mechanical components.

In an embodiment, a design of the device is modified or otherwise reconfigured based on the result of the simulation (250). The design may be altered by the location of one or more components or circuits, and/or through the addition of layers (e.g., addition of VSD layer). For example, the modifications can include (i) altering the position of the embedded ESD component, (ii) altering the shape, configuration, or type of ESD component (e.g., VSD material), and/or (iii) identifying and selectively locating impedance elements in the layout in order to set impedance values, particularly in the manner in which ESD inlets, for example, electrically interconnect to the ESD component. Additionally, the circuit elements and/or electrical components can be reclassified, and operations of the method may be performed again. In various embodiments, simulation can be performed iteratively multiple times on an electronic device, with each subsequent design being simulated again for ESD performance and being further revised based on the results of the last simulation.

Determinations may also be made as to (i) which circuit elements and/or electronic components should be electrically connected to embedded ESD components and/or impedance elements for ESD protection, and/or (ii) where and how particular ESD components and/or impedance elements should be disposed relative to the circuit elements. For example, those circuit elements and/or electrical components assigned to the second class (see 234, “maybe” include ESD protection) can be evaluated further to determine whether the benefit of using the embedded ESD component outweighs the cost or detriment. The determinations may encompass identifying those circuits or components that may have detrimental electrical effect from the use of ESD components (e.g., unwanted parasitic capacitance from VSD material). Additional considerations may include cost or complexity in using the embedded ESD components with such components or elements.

The simulation and modification process may be repeated as desired (260). When modification occurs, the design may be simulated to ensure its operation, including confirmation that circuit elements and/or electrical components of the device perform as expected. The simulation may also check the response of the circuit elements and/or electrical components to electrical events such as ESD, to ensure the simulation does not identify, for example, any unexpected points of failure. When desired simulation results are achieved, a layout of the electrical system for the device is programmatically determined (270).

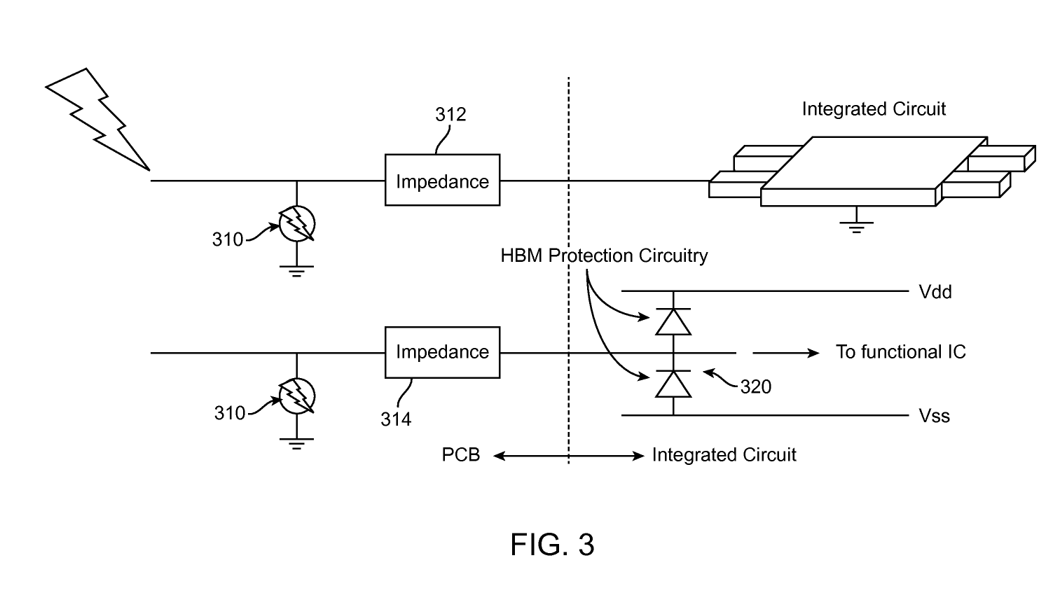

FIG. 3 illustrates a simulation of a device that handles an ESD event, according to an embodiment. More specifically, FIG. 3 illustrates an embodiment in which a protective design of a device includes an ESD component comprising (i) VSD material 310 to handle large amounts of energy resulting from the ESD event, and (ii) impedance elements 312, 314 that are selected and positioned to protect more sensitive elements, such as integrated circuits, against high voltages and/or currents generated by ESD events. In one embodiment, the majority of the current is captured by the VSD layer 310, and the remaining current is reduced to acceptable levels.

In the example shown, impedance elements 312, 314 and VSD material 310 are used to protect a device on both a system and component level. The configuration of the protective elements, including the impedance associated with the VSD and the integrated circuits, can be determined by process of simulation. In particular, simulation enables intelligent selection of electrical elements that provide desired (as determined by simulation) impedance levels for routing current to VSD as needed. Among other benefits, simulating a device at system level and under an ESD pulse enables a quantitative determination of impedance levels for intelligently routing and utilizing VSD layers and components of the device. In an embodiment such as shown, system level conditions may be satisfied through the design of the VSD material.

Impendence elements 312, 314 may be selected and configured to attenuate currents and/or voltages produced in response to an ESD pulse.

Embodiments further provide that some component level protection may be provided through use of, for example, protection circuitry or discrete elements. In the example provided by FIG. 3, protection circuitry 320 is provided to protect those elements of the device that can be sensitive to, for example, HBM level charges. The HBM protection circuit 320 shown in FIG. 3 is formed from of two reversed biased diodes to power and ground rails. In an example described, total impedance through HBM protection circuit is ˜1Ω. The HBM protection circuit 320 can be expected to withstand an event in which the total energy is lower than what is experienced during a maximum-rated HBM pulse.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computer implemented method for designing an electronic device, the method being implemented by one or more processors and comprising:
(a) designing the electronic device to include an embedded electrostatic discharge(ESD) component in electrical communication with an electronic component; and
(b) selecting one or more impedance elements and positioning the one or more impedance elements in electrical communication with the embedded ESD component and with the electronic component,
wherein the embedded ESD component and the one or more impedance elements are adapted to protect the electronic component against an ESD pulse.

2. The method of claim 1, wherein the embedded ESD component includes a layer of voltage switchable dielectric (VSD) material.

3. The method of claim 1, wherein the embedded ESD component includes one or more components selected from a group consisting of a voltage switchable dielectric (VSD) component, a varistor material, a silicon diode, a metal oxide varistor, a transient voltage suppression (TVS) component, or a zener diode.

4. The method of claim 1, wherein (b) includes positioning the one or more impedance elements to between the embedded ESD component and the electronic component.

5. The method of claim 1, wherein the electronic component corresponds to one of individual connector inputs (external and internal), buttons, antenna pads, touchscreens.

6. A computer-implemented method for designing an electrical system of a device, the method comprising:
evaluating the electrical system, including multiple circuit elements and/or electrical components; and
determining, from analyzing the electrical system, (i) a first class of circuit elements and/or electrical components that satisfy one or more conditions for electrically connecting to voltage switchable dielectric (VSD) material for protection against electrical events that exceed a threshold; and (ii) a second class of circuit elements and/or electrical components that satisfy one or more conditions for not electrically connecting to VSD material.

7. The method of claim 6, further comprising enabling a designer to implement a design in which at least a first layer of VSD material is connected to individual circuit elements and/or electrical components of the first class.

8. The method of claim 7, further comprising simulating the electrical system of the device with the first layer of VSD material being connected to individual circuit elements and/or electrical components of the first class.

9. The method of claim 6, further comprising (iii) determining a third class of circuit elements and/or electrical components that satisfy one or more conditions of the first class for electrically connecting to VSD material, but which are negatively impacted in performance of functionality as a result of being positioned to electrically connect to VSD material.

10. The method of claim 6, wherein evaluating the electrical system includes simulating the electrical system of the device as a whole under presence of an ESD pulse.

11. The method of claim 6, wherein evaluating the electrical system includes simulating a portion of the electrical system of the device under presence of an ESD pulse.

12. The method of claim 11, wherein the portion of the electrical system includes one or more of a circuit element, a chip, an electrical circuit, and/or a mechanical component.

13. The method of claim 12, wherein evaluating the electrical system includes simulating one or more of a current response or frequency response to an electrostatic discharge (ESD) pulse by one or more circuit elements and/or electrical components of the electrical system.

14. The method of claim 6, wherein determining (ii) includes determining that a parasitic capacitance from presence of the VSD material is detrimental to performance of one or more of the circuit elements and/or electrical components of the second set.

15. A system for protecting a computing device against harmful electrical events, the system comprising:
a plurality of electrical elements, including a first subset of electrical elements that are sensitive to electrical events that exceed at least a first threshold, and a second subset of electrical elements that are sensitive to electrical events that exceed at least a second threshold that is greater than the first threshold;
one or more layers of voltage switchable dielectric (VSD) material; and
one or more impedance elements that are selected and positioned to protect one or more of the electrical elements in the first subset.

16. The system of claim 15, wherein the one or more impedance elements are configured to guide a charge from an electrical event onto an electrical path that is connected to one or more of the layers of VSD material.

17. A computing device comprising:
a plurality of electrical elements, including a first subset of electrical elements that are deemed to be sensitive to electrical events that exceed at least a first threshold, and a second subset of electrical elements that are deemed to be sensitive to electrical events that exceed at least a second threshold that is greater than the first threshold;
one or more layers of voltage switchable dielectric (VSD) material; and
one or more impedance elements that are selected and positioned to protect one or more of the electrical elements in the first subset.

18. The computing device of claim 17, wherein the one or more impedance elements are configured to guide a charge from an electrical event onto an electrical path that is connected to one or more of the layers of VSD material.

19. The computing device of claim 17, wherein one or more of the layers of VSD material are positioned to conduct current in response to an electrical event that originates from the operation of a display screen of the computing device.

20. The computing device of claim 17, wherein one or more of the layers of VSD material are positioned to conduct current in response to an electrical event that originates from the operation of an antenna element of the computing device.
